(19) United States
(12) Patent Application Publication
(10) Pub. No.: US 2023/0342739 A1
(43) Pub. Date: Oct. 26, 2023

(54) GLOBAL GUARANTEED FUTURE ELECTRONIC CHECK SYSTEM AND METHOD OF USING THE SAME

(71) Applicant: Waleed Haddad, Amman (JO)

(72) Inventor: Waleed Haddad, Amman (JO)

(21) Appl. No.: 17/724,573

(22) Filed: Apr. 20, 2022

(51) Int. Cl. G06Q 20/10; G06Q 20/06; G06Q 20/40

(52) U.S. Cl. CPC G06Q 20/108; G06Q 20/065; G06Q 20/4014

(57) ABSTRACT

A system and method of issuing guaranteed future electronic checks may include automatically connecting to an e-check receiving account and may include a cash date that may be automatically cashed by the system into a receiving account and to be paid by the guaranteed check issuing bank system.

### TECHNICAL FIELD

The embodiments generally relate to methods of electronic checks.

### BACKGROUND

Traditional checks operate as non-cash payment methods but may fail to meet requirements for payees seeking guaranteed payment methods other than cash or electronic credit.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide a system and method of authorizing, clearing, and settling guaranteed electronic checks.

The embodiments disclosed herein provide a system and method of issuing guaranteed future electronic checks. Guaranteed checks may be automatically connected to an e-check receiving account and may include a future cash date that may be automatically cached by the system into a receiving account and to be paid by the guaranteed check issuing bank system.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a diagram of a guaranteed future electronic check system configured to support a method of issuing and clearing guaranteed electronic checks according to a variety of embodiments disclosed herein.

FIG. 2 illustrates a flowchart for a method of issuing and clearing guaranteed electronic checks according to a variety of embodiments disclosed herein.

FIG. 3 illustrates a flowchart for a method of issuing and clearing guaranteed electronic checks according to a variety of embodiments disclosed herein.

FIG. 4 illustrates a flowchart for a method of issuing and clearing guaranteed electronic checks according to a variety of embodiments disclosed herein.

FIG. 5 illustrates a flowchart for a method of issuing and clearing guaranteed electronic checks according to a variety of embodiments disclosed herein.

FIG. 6 illustrates a diagram of a guaranteed future electronic check system configured to support a method of issuing and clearing guaranteed electronic checks according to a variety of embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

As used herein, the term “user(s)” may refer to an individual or entity who directly interacts with a graphical user interface of the system disclosed herein. The term “user(s)” may also refer to an individual or entity indirectly interacting with the disclosed system.

As used herein, “GUI” may refer to any graphical user interface that includes at least one interactive component between a user and the application. A GUI may include a plurality of fillable fields, clickable buttons, database displays, or the like. A GUI maybe adaptable for use on several devices such as computers, phones, smart devices, tablets, laptops, televisions, or the like.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, “controller” may include a system including an electronic processor and configured to produce and/or execute control signals. Such a controller may be a distributed computing device such as a cloud computing system, or a localized computing system such as a field programmable gate array. The term “controller” as used herein may include a hybrid control system comprising, for example, edge computing devices configured to communicate with a remote computing system (e.g., a cloud computing system) and to share any described control tasks with the remote computing system.

In some embodiments, the methods described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integrated into the processor. Further, in some embodiments, the processor and the storage medium may reside in an Application Specific Integrated Circuit (ASIC). The processor and the storage medium may also reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, computer readable instructions executable by a controller and configured to carry out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The executable instructions can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the executable instructions can be downloaded to a computing/processing device from a computer readable storage medium, or to an external computer or external storage device via a network. A network adapter card or network interface in each computing/processing device receives computer readable program instructions from the network and forwards the computer readable executable instructions for storage in a computer readable storage medium within the respective computing/processing device.

Any connection between the components of the disclosed system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

The system and method of issuing guaranteed future electronic checks may include linking an issuing banking system to a global guaranteed electronic check system via an application programming interface in operable communication with a network. The issuing banking system may include an issuing bank or financial institution that may guarantee future electronic checks based on an issuing account holder's held funds or issued credit. An issuing account holder may submit a request through the system for at least one guaranteed electronic check to be issued to a receiving account and a receiving financial institution or banking system. The request may be made via computing device such as a smartphone to the system, which may communicate the request to the issuing banking system. The issuing banking system may receive the issuing request and the system may verify the received request for the guaranteed electronic check with the issuing banking system. The system and method may include issuing at least one guaranteed electronic check and receiving the guaranteed electronic check at the guaranteed electronic check system. The system and method may include storing a copy of the guaranteed electronic check in a data storage structure and systematically verifying the authenticity of the guaranteed electronic check with the issuing banking system. The system and method may include storing a copy of the verification of authenticity in the data storage structure correlating to the copy of the guaranteed electronic check.

The system and method of issuing guaranteed future electronic checks may include facilitating clearance of the guaranteed electronic check between the first banking system and a second banking system, including at least debiting the first banking system a first debit; communicating, over the network, an adjustment of the first banking system to reflect the first debit; crediting the second banking system a first credit equivalent to the first debit; and communicating, over the network, an adjustment of the second banking system to reflect the first credit.

The system and method of issuing guaranteed future electronic checks may further include storing a record of the clearance of the guaranteed electronic check within the data storage structure correlating to the copy of the verification of authenticity and the copy of the at least one guaranteed electronic check. The system and method of issuing guaranteed future electronic checks may include communicating the record of the clearance to the at least one first banking system and the at least one second banking system.

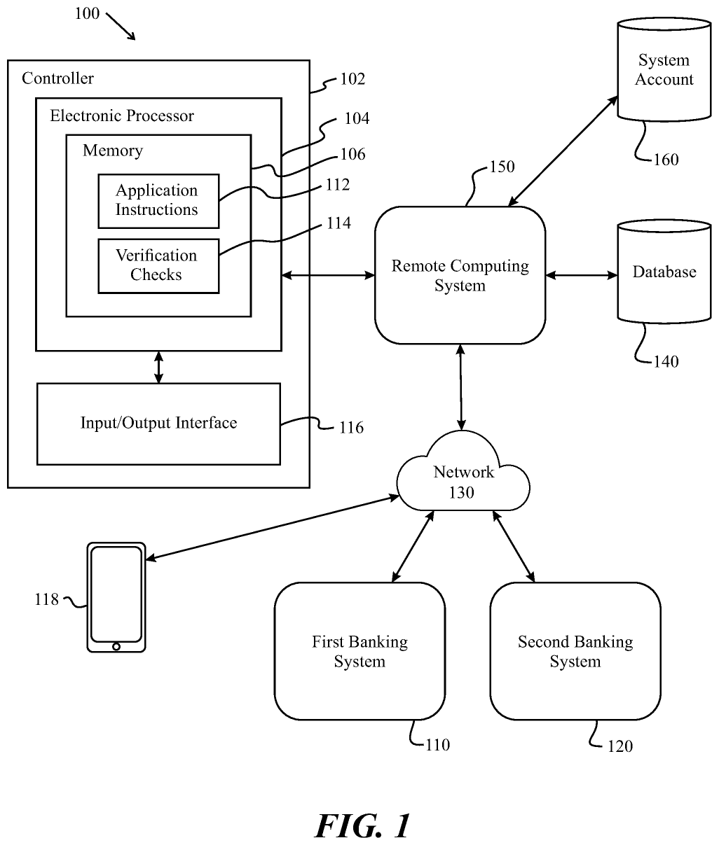

In reference to FIG. 1, a system for issuing guaranteed electronic checks 100 comprises a controller 102 including an electronic processor 104 and an input/output interface 116. The controller 102 is configured to perform application instructions 112 and perform and update verification checks 114 in a memory 106 of the electronic processor 104 based on the received data. The memory 106 is configured to perform, store, and update verification checks 114. As will be described in further detail, the verification checks 114 are correlated by the controller 102 to copies of guaranteed electronic checks, verifications of electronic check authenticity, and records of the check clearance. Verification checks 114, including guaranteed electronic checks, verifications of electronic check authenticity, and records of the check clearance may be stored in a database 140. The input/output interface 116 is configured to serve as a communication interface between the controller 102 and system-side users, managers, developers, and the like. A remote computing system 150 is configured to send data to and receive data from the electronic processor 104 and may also be configured to send data to and receive data, via a network 130, from the user device 118, first banking systems 110 such as check issuing financial institutions, and second banking systems 120 such as check receiving financial institutions. The remote computing system 150 may also be configured to analyze any received data, according to the methods disclosed here in, and to communicate the results of that analysis to the controller 102. According to some embodiments, the system for issuing guaranteed electronic checks 100 may include system account 160 functionality for users, including checking, savings, or electronic wallet banking functionality.

In some embodiments, the network 130 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 130 can comprise copper transmission cables, optical transmission fibers, wireless transmission, routers, firewalls, switches, gateway computers and/or edge servers. The network 130 can represent a single network or multiple networks. In some embodiments, the network 130 used by the various devices of system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

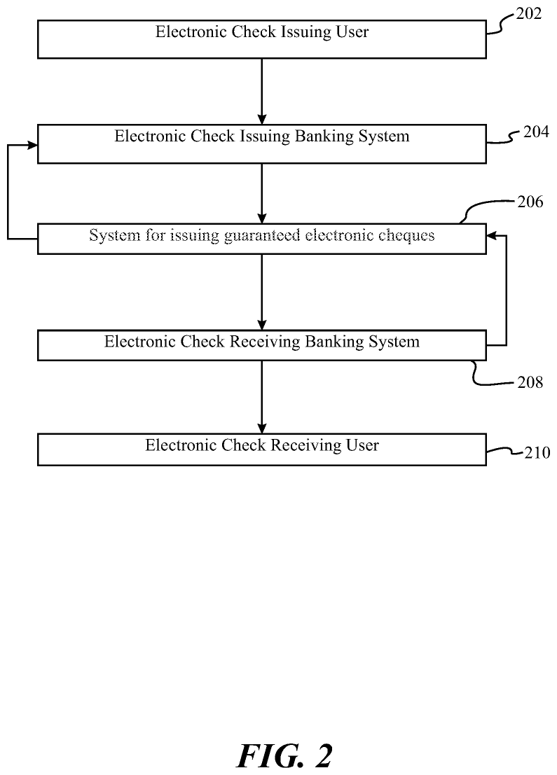

In reference to FIG. 2, system for issuing guaranteed electronic checks may include an electronic guaranteed check issuing user 202 making a request for issuance of an electronic guaranteed check to an electronic check issuing banking system 204. The electronic check issuing banking system 204 may issue the electronic guaranteed check to the system for issuing guaranteed electronic checks 206 which may store a copy of the issued check and verify the authenticity of the check with the electronic check issuing banking system 204. The system for issuing guaranteed electronic checks 206 may issue the electronic check to a receiving banking system 208 and verify receipt of the issued electronic check to the receiving banking system 208. The receiving banking system 208 may issue the electronic check to an electronic check receiving user 210. The system for issuing guaranteed electronic checks may further facilitate clearing of the issued guaranteed check between the issuing banking system 204 in the receiving banking 208.

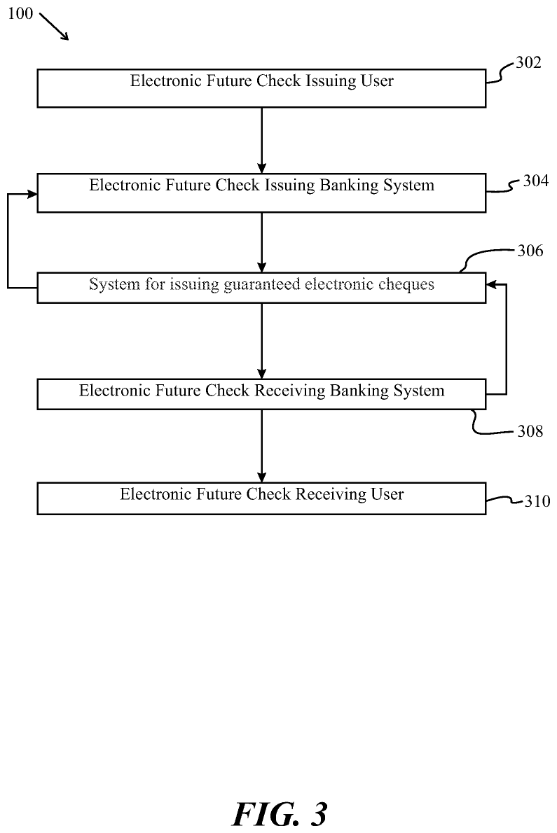

In reference to FIG. 3, system for issuing guaranteed future electronic checks may include the issuance of future guaranteed checks including information relating to a specified cashing or clearing date. The system may include an electronic guaranteed check issuing user 302 making a request for issuance of a future electronic guaranteed check to an electronic check issuing banking system 304 including a specified cash date. The electronic check issuing banking system 304 may issue the future electronic guaranteed check to the system for issuing guaranteed electronic checks 306 which may store a copy of the future issued check and verify the authenticity of the future check with the electronic check issuing banking system 304. The system for issuing future guaranteed electronic checks 306 may issue the future electronic check to a receiving banking system 308 and verify receipt of the future issued electronic check to the receiving banking system 308. The receiving banking system 308 may issue the future electronic check to an electronic check receiving user 310. The system for issuing future guaranteed electronic checks may delay cashing or clearing of the future issued guaranteed check between the issuing banking system 304 in the receiving banking 308 on the specified cash date at which point the system would trigger cashing or clearing of the future issued guaranteed check.

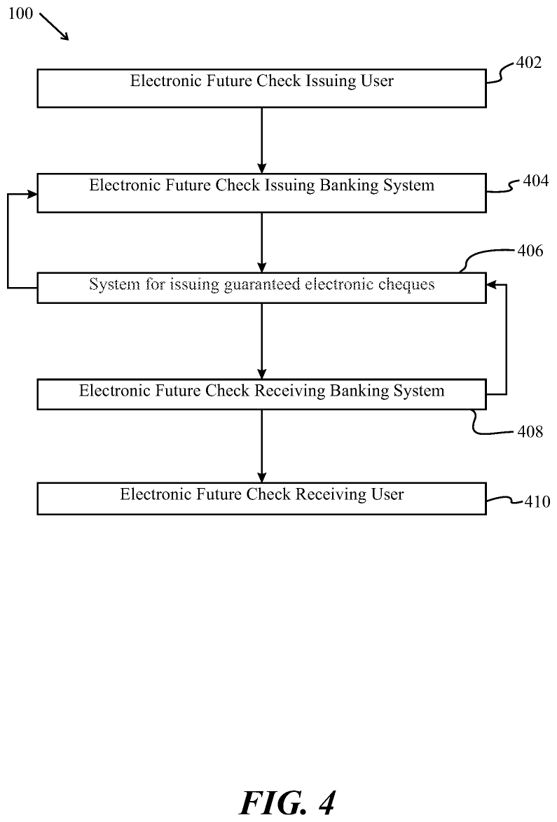

In reference to FIG. 4, system for issuing guaranteed future electronic checks may include the issuance of future guaranteed checks including information relating to a specified cashing or clearing date. The system may include an electronic guaranteed check issuing user 402 making a request for issuance of a future electronic guaranteed check to an electronic check issuing banking system 404 including a specified cash date. The electronic check issuing banking system 404 may issue the future electronic guaranteed check to the system for issuing guaranteed electronic checks 406 which may store a copy of the future issued check and verify the authenticity of the future check with the electronic check issuing banking system 404. The electronic check issuing banking system 404 may transfer the funds associated with the issued guaranteed future electronic check to the system for issuing guaranteed electronic checks 406 which may hold transferred funds from the electronic check issuing banking system 404. The system for issuing future guaranteed electronic checks 306 may issue the future electronic check to a receiving banking system 408 and verify receipt of the future issued electronic check to the receiving banking system 408. The system for issuing guaranteed electronic checks 406 may transfer the funds associated with the issued guaranteed future electronic check to the receiving banking system 308. The receiving banking system 408 may issue the future electronic check to an electronic check receiving user 410. The system for issuing future guaranteed electronic checks may delay cashing or clearing of the future issued guaranteed check between the issuing banking system 404 in the receiving banking 408 on the specified cash date at which point the system would trigger cashing or clearing of the future issued guaranteed check.

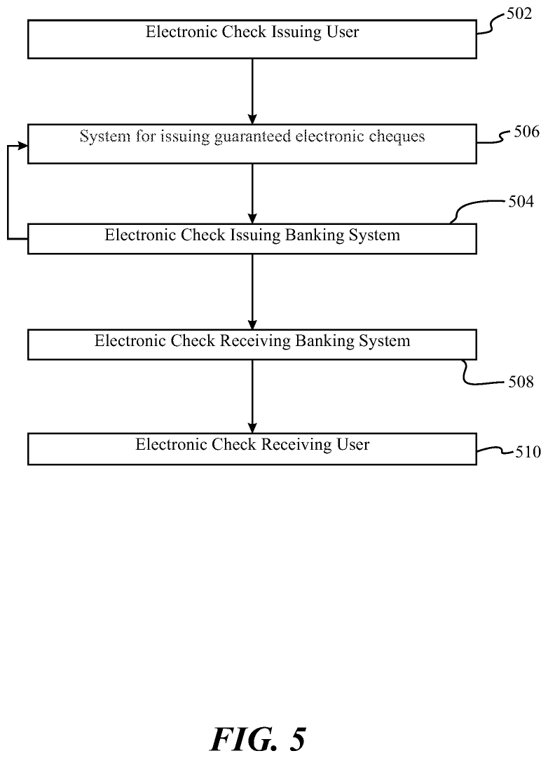

In reference to FIG. 5, system for issuing guaranteed electronic checks may include an electronic guaranteed check issuing user 502 making a request for issuance of an electronic guaranteed check to the system for issuing guaranteed electronic checks 506. The system for issuing guaranteed electronic checks 506 may verify with the electronic check issuing banking system 504 that the requesting user 502 has funds or credit limit to issue the electronic guaranteed check to an electronic check issuing banking system 504. The system for issuing guaranteed electronic checks 506 may request reservations of the funds or credit limit of the requesting user. The system for issuing guaranteed electronic checks 506 may issue the electronic guaranteed check to an electronic check issuing banking system 504. The system for issuing guaranteed electronic checks 506 may store a copy of the issued check. The electronic check issuing banking system 504 may issue the electronic check to a receiving banking system 508 and verify receipt of the issued electronic check to the system for issuing guaranteed electronic checks 506. The receiving banking system 508 may issue the electronic check to an electronic check receiving user 510. The system for issuing guaranteed electronic checks may further facilitate clearing of the issued guaranteed check between the issuing banking system 504 in the receiving banking 508.

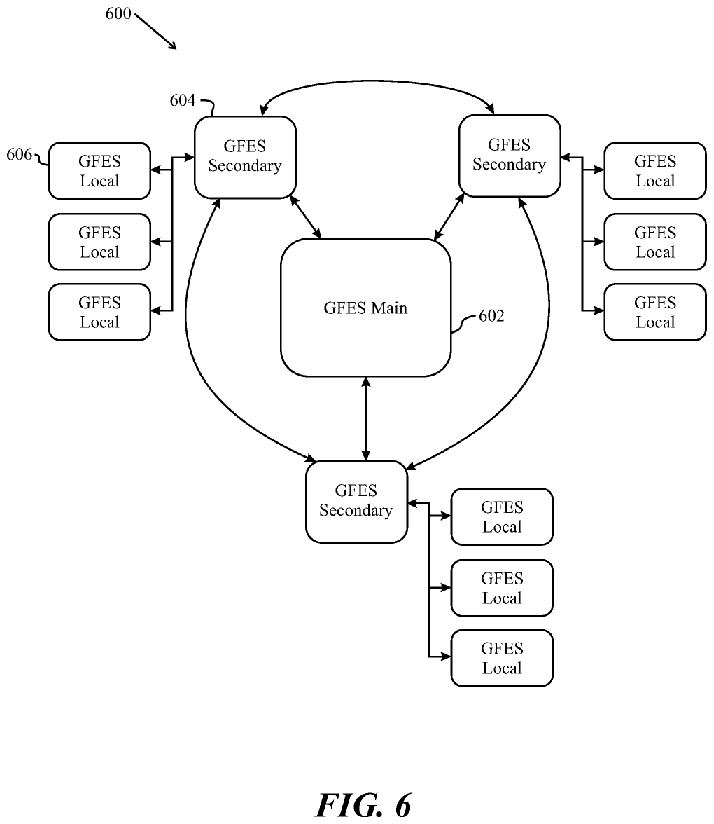

In reference to FIG. 6, a network 600 of systems for issuing guaranteed electronic checks may include a plurality of local global guaranteed future electronic check systems (GFES) 606. Local GFES 606 may be in operable communication with Regional GFES 604 in operable communication with at least one Main GFES 602.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, A non-transitory computer-readable medium having computer executable instructions for managing financial accounts stored thereon that are executed by a processor to issue and clear guaranteed electronic checks, wherein the computer executable instructions include linking at least one banking system to a global guaranteed electronic check system via an application programming interface in operable communication with a network; receiving a request for at least one guaranteed electronic check; verifying the request for the at least one guaranteed electronic check with the at least one banking system; issuing at least one guaranteed electronic check; receiving the at least one guaranteed electronic check at the global guaranteed electronic check system; storing a copy of the at least one guaranteed electronic check in a data storage structure; verifying the authenticity of the at least one guaranteed electronic check with the at least one first banking system; storing a copy of the verification of authenticity in the data storage structure correlating to the copy of the at least one guaranteed electronic check; facilitating clearance of the at least one guaranteed electronic check between the at least one first banking system and at least one second banking system, including debiting the at least one first banking system a first debit; communicating, over the network, an adjustment of the at least one first banking system to reflect the first debit; crediting the at least one second banking system a first credit equivalent to the first debit; and communicating, over the network, an adjustment of the at least one second banking system to reflect the first credit; storing a record of the clearance of the at least one guaranteed electronic check within the data storage structure correlating to the copy of the verification of authenticity and the copy of the at least one guaranteed electronic check; and communicating, over the network, the record of the clearance to the at least one first banking system and the at least one second banking system.

Variation 2 may include a non-transitory computer-readable medium having computer executable instructions for managing financial accounts stored thereon that are executed by a processor to issue and clear guaranteed electronic checks as in variation 1, wherein verifying the request for the at least one guaranteed electronic check with the at least one banking system comprises confirming that the at least one banking system guarantees source funds for an issued guaranteed electronic check.

Variation 3 may include a non-transitory computer-readable medium having computer executable instructions for managing financial accounts stored thereon that are executed by a processor to issue and clear guaranteed electronic checks as in any of variations 1 through 2, wherein confirming that the at least one banking system guarantees source funds for an issued guaranteed electronic check includes confirming that the at least one banking system guaranteed the issued guaranteed electronic check based on a line of credit

Variation 4 may include a non-transitory computer-readable medium having computer executable instructions for managing financial accounts stored thereon that are executed by a processor to issue and clear guaranteed electronic checks as in any of variations 1 through 3, wherein confirming that the at least one banking system guarantees source funds for an issued guaranteed electronic check includes confirming that the at least one banking system guaranteed the issued guaranteed electronic check based on at least one of a line of credit or a checking account containing request maker funds.

Variation 5 may include a non-transitory computer-readable medium having computer executable instructions for managing financial accounts stored thereon that are executed by a processor to issue and clear guaranteed electronic checks as in any of variations 1 through 4, wherein facilitating clearance of the at least one guaranteed electronic check between the at least one first banking system and at least one second banking system occurs on a predetermined due date.

Variation 6 may include a non-transitory computer-readable medium having computer executable instructions for managing financial accounts stored thereon that are executed by a processor to issue and clear guaranteed electronic checks as in any of variations 1 through 5, further comprising compiling the stored copy of the at least one guaranteed electronic check, copy of the verification of authenticity, and record of the clearance of the at least one guaranteed electronic check within the data storage structure.

According to variation 7, non-transitory computer-readable medium having computer executable instructions for managing financial accounts stored thereon that are executed by a processor to issue and clear guaranteed electronic checks, wherein the computer executable instructions may include linking at least one banking system to a global guaranteed electronic check system via an application programming interface in operable communication with a network; receiving a request for at least one guaranteed electronic check; issuing at least one guaranteed electronic check; receiving the at least one guaranteed electronic check at the global guaranteed electronic check system; storing a copy of the at least one guaranteed electronic check in a data storage structure; facilitating clearance of the at least one guaranteed electronic check between the at least one first banking system and at least one second banking system, including debiting the at least one first banking system a first debit; communicating, over the network, an adjustment of the at least one first banking system to reflect the first debit; crediting the at least one second banking system a first credit equivalent to the first debit; and communicating, over the network, an adjustment of the at least one second banking system to reflect the first credit; and communicating, over the network, a record of the clearance to the at least one first banking system and the at least one second banking system.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A non-transitory computer-readable medium having computer executable instructions for managing financial accounts stored thereon that are executed by a processor to issue and clear guaranteed electronic checks, wherein the computer executable instructions comprise:
linking at least one banking system to a global guaranteed electronic check system via an application programming interface in operable communication with a network;
receiving a request for at least one guaranteed electronic check;
verifying the request for the at least one guaranteed electronic check with the at least one banking system;
issuing at least one guaranteed electronic check;
receiving the at least one guaranteed electronic check at the global guaranteed electronic check system;
storing a copy of the at least one guaranteed electronic check in a data storage structure;
verifying the authenticity of the at least one guaranteed electronic check with the at least one first banking system;
storing a copy of the verification of authenticity in the data storage structure correlating to the copy of the at least one guaranteed electronic check;
facilitating clearance of the at least one guaranteed electronic check between the at least one first banking system and at least one second banking system, comprising:
debiting the at least one first banking system a first debit;
communicating, over the network, an adjustment of the at least one first banking system to reflect the first debit;
crediting the at least one second banking system a first credit equivalent to the first debit; and
communicating, over the network, an adjustment of the at least one second banking system to reflect the first credit;
storing a record of the clearance of the at least one guaranteed electronic check within the data storage structure correlating to the copy of the verification of authenticity and the copy of the at least one guaranteed electronic check; and
communicating, over the network, the record of the clearance to the at least one first banking system and the at least one second banking system.

2. A non-transitory computer-readable medium having computer executable instructions for managing financial accounts stored thereon that are executed by a processor to issue and clear guaranteed electronic checks as in claim 1, wherein verifying the request for the at least one guaranteed electronic check with the at least one banking system comprises confirming that the at least one banking system guarantees source funds for an issued guaranteed electronic check.

3. A non-transitory computer-readable medium having computer executable instructions for managing financial accounts stored thereon that are executed by a processor to issue and clear guaranteed electronic checks as in claim 2, wherein confirming that the at least one banking system guarantees source funds for an issued guaranteed electronic check includes confirming that the at least one banking system guaranteed the issued guaranteed electronic check based on a line of credit.

4. A non-transitory computer-readable medium having computer executable instructions for managing financial accounts stored thereon that are executed by a processor to issue and clear guaranteed electronic checks as in claim 2, wherein confirming that the at least one banking system guarantees source funds for an issued guaranteed electronic check includes confirming that the at least one banking system guaranteed the issued guaranteed electronic check based on at least one of a line of credit or a checking account containing request maker funds.

5. A non-transitory computer-readable medium having computer executable instructions for managing financial accounts stored thereon that are executed by a processor to issue and clear guaranteed electronic checks as in claim 1, wherein facilitating clearance of the at least one guaranteed electronic check between the at least one first banking system and at least one second banking system occurs on a predetermined due date.

6. A non-transitory computer-readable medium having computer executable instructions for managing financial accounts stored thereon that are executed by a processor to issue and clear guaranteed electronic checks as in claim 1, further comprising compiling the stored copy of the at least one guaranteed electronic check, copy of the verification of authenticity, and record of the clearance of the at least one guaranteed electronic check within the data storage structure.

7. A non-transitory computer-readable medium having computer executable instructions for managing financial accounts stored thereon that are executed by a processor to issue and clear guaranteed electronic checks, wherein the computer executable instructions comprise:
linking at least one banking system to a global guaranteed electronic check system via an application programming interface in operable communication with a network;
receiving a request for at least one guaranteed electronic check;
issuing at least one guaranteed electronic check;
receiving the at least one guaranteed electronic check at the global guaranteed electronic check system;
storing a copy of the at least one guaranteed electronic check in a data storage structure;
facilitating clearance of the at least one guaranteed electronic check between the at least one first banking system and at least one second banking system, comprising:
debiting the at least one first banking system a first debit;
communicating, over the network, an adjustment of the at least one first banking system to reflect the first debit;
crediting the at least one second banking system a first credit equivalent to the first debit; and
communicating, over the network, an adjustment of the at least one second banking system to reflect the first credit; and
communicating, over the network, a record of the clearance to the at least one first banking system and the at least one second banking system.
